(19) United States
(12) Patent Application Publication
(10) Pub. No.: US 2002/0036954 A1
(43) Pub. Date: Mar. 28, 2002

(54) Ultrasonic sensor having diaphragm

(76) Inventors: Hiroyuki Kani, Okazaki-city (JP); Yasuhiro Kawashima, Okazaki-city (JP); Takeo Tsuzuki, Toyota-city (JP)

Correspondence Address: LAW OFFICE OF DAVID G POSZ, 2000 L STREET, N.W., SUITE 200, WASHINGTON, DC, 20036, US

(21) Appl. No.: 09/920,719

(22) Filed: Aug. 3, 2001

(30) Foreign Application Priority Data
Aug. 11, 2000 (JP) 2000-245155

(51) Int. Cl. H04R 17/00

(52) U.S. Cl. 367/163; 367/162

(57) ABSTRACT

An ultrasonic sensor has a sensor body, a diaphragm, and a vibrator for generating ultrasonic and attached to the diaphragm. The diaphragm has a thinnest portion. The thinnest portion has a predetermined thickness by which reverberation of the diaphragm is restrained. The reflected ultrasonic can be detected correctly by this construction of the sensor.

### CROSS REFERENCE TO RELATED APPLICATION

This application is based upon Japanese Patent Application No. 2000-245155 filed on Aug. 11, 2000, the contents of which are incorporated herein by reference.

### BACKGROUND OF THE INVENTION

1. Field of the Invention:

The present invention relates to an ultrasonic sensor, which is employed to a hazard warning device for detecting an obstruction around a vehicle, and for waning a user of the vehicle of danger that the vehicle may hit the obstruction when the user parks the vehicle or turns the vehicle.

2. Related Art:

Recently, an active clearance sonar using ultrasonic has been proposed, which is used for detecting a distance between a vehicle and an obstruction, and for warning a user of the vehicle. An ultrasonic sensor, which is a drop-proof type, is usually employed to such a kind of sonar. Various ingenuities are adopted to the ultrasonic sensor for thinning a vibrating portion of the sensor to enhance a transmitting power.

In such the ultrasonic sensor having a thin vibrating portion (diaphragm), when a water droplet attaches to the diaphragm, vibration characteristic changes and an elapsed time of reverberation is lengthened. Thus, the clearance sonar may not detect the obstruction correctly, or may malfunction (for example, the sonar warns the user even if there is no obstruction).

Moreover, a clearance sonar has been proposed, which does not have a horn so as to expose an ultrasonic sensor. Therefore, measures for the water droplet are even more desired.

### SUMMARY OF THE INVENTION

This invention has been conceived in view of the background as described above and an object of the invention is to provide an ultrasonic sensor capable of restraining vibration characteristic from changing efficiently even when substance such as a water droplet adheres to a diaphragm of the sensor, whereby reverberant vibration is restrained so as to determine an exist of an obstruction exactly.

According to a first aspect of the invention, a thickness of a diaphragm of an ultrasonic sensor is defined based on duration time of reverberation. More concretely, the diaphragm of the ultrasonic sensor has a predetermined thickness to prevent the duration time of reverberation from being lengthened.

By adjusting the thickness of the diaphragm of the ultrasonic sensor, the reverberation of the diaphragm does not continue until reception time of reflected ultrasonic from an outside of the sensor after an activation of the diaphragm is stopped, even if a water droplet adheres to the diaphragm. As a result, an ultrasonic sonar having the ultrasonic sensor therein can detect an obstruction correctly, and being prevented from malfunctioning.

Preferably, the thickness of the diaphragm is defined so that the reverberation has disappeared by a time that outputted ultrasonic, which is outputted from the diaphragm and is reflected by the obstruction, returns to the diaphragm. That is, the duration time of the reverberation does not overlap a reception time of the outputted ultrasonic that returns to the diaphragm.

More preferably, the diaphragm has a thickness of 0.4 mm or more at a thinnest portion thereof.

More preferably, the thinnest portion is located at an end of the diaphragm.

Other features and advantages of the present invention will become more apparent from the following detailed description made with reference to the accompanying drawings.

### BRIEF DESCRIPTION OF THE DRAWINGS

FIG. 1A is a from view of an ultrasonic sensor of an embodiment of the present invention;

FIG. 1B is a partial cross sectional view of the ultrasonic sensor taken along line IB-IB in FIG. 1A;

FIG. 2 is a block diagram of the ultrasonic sensor;

FIG. 3 is a flow chart showing detection and warning sequence of the ultrasonic sensor;

FIG. 4 is a waveform of an oscillation caused by reverberation of a diaphragm;

FIG. 5 is a waveform of an oscillation caused by reverberation of a diaphragm in case where the reverberation is long;

FIG. 6A is a graph showing a relationship between reverberation time and a thickness of a thinnest portion of the diaphragm;

FIG. 6B is a graph showing a relationship between reverberation time and a thickness ratio of a thinnest portion and a thickness portion of the diaphragm;

FIG. 7 is a graph showing a relationship between probability density and the reverberation time in case where a thickness of the thinnest portion of the diaphragm is 0.3 mm; and

FIG. 8 is a graph showing a relationship between probability density and the reverberation time in case where the thickness of the thinnest portion of the diaphragm is 0.4 mm.

### DETAILED DESCRIPTION OF THE PREFERRED EMBODIMENT

Specific embodiments of the present invention will now be described hereinafter with reference to the accompanying drawings in which the same or similar component parts are designated by the same or similar reference numerals.

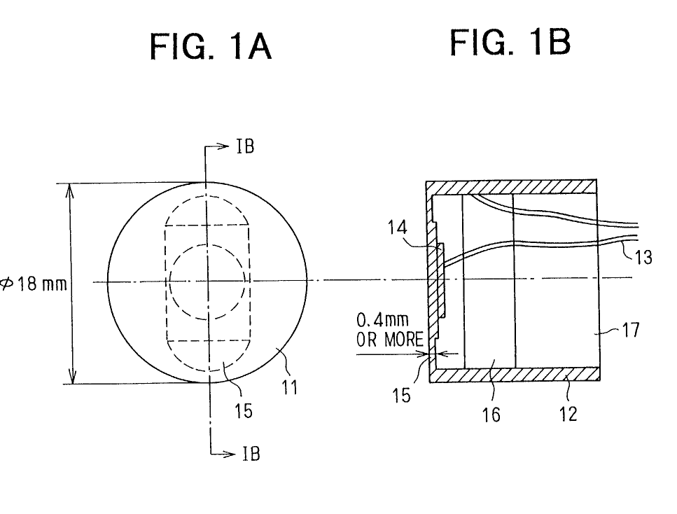

Referring to FIGS. 1A and 1B, an ultrasonic sensor has a diaphragm (vibration plate) 11 formed at an end of a cylindrically sensor case 12 which is typically made of aluminum alloy, lead wirings 13 to transmit electric power, a piezoelectric vibrator (PZT) 14 attached to an inner surface of the diaphragm 11, a sponge 16 for absorbing ultrasonic transmitted to an inside of the sensor case 12, and a resin 17 typically made of silicone rubber.

The diaphragm has thinnest portions 15 disposed at an upper portion and a lower portion with respect to a center portion in FIG. 1A. The thinnest portions 15 form a semicircle, respectively, and a chord of the semicircle is connected to the center portion in each thinnest portion 15. The piezoelectric vibrator 14 is attached to the center portion of the diaphragm as shown in FIG. 1A. Incidentally, the center portion of the diaphragm 11 has a thickness of 0.7 mm (thickest portion in the diaphragm 11).

In activation of the ultrasonic sensor, the piezoelectric vibrator 14 vibrates by being applied electric power having a predetermined frequency (for example, 40 KHz) thereto, so that the diaphragm 11 vibrates. Accordingly, ultrasonic is emitted from the diaphragm 11.

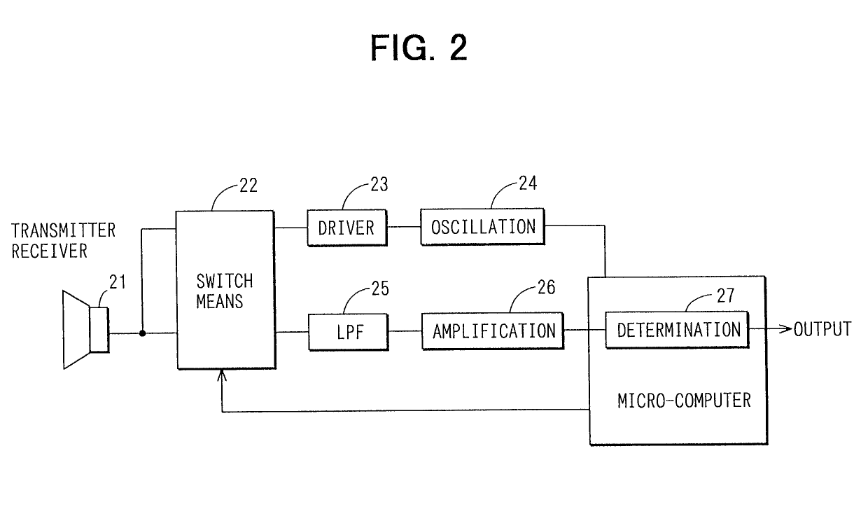

Referring to FIG. 2, an ultrasonic sonar including the ultrasonic sensor has an ultrasonic transmitter-receiver 21, a transmission and reception switching means 22, a driver 23 for driving the ultrasonic sensor, an oscillation circuit 24 for applying oscillation signal to the driver 23, a LPF (Low Pass Filter) 25 for filtering noise off from an ultrasonic reception signal, an amplification circuit 26 for amplifying the ultrasonic reception signal, a detecting means 27 for detecting disturbance in the ultrasonic reception signal.

Incidentally, the ultrasonic sonar is mounted on a vehicle at a front or rear bumper, for example.

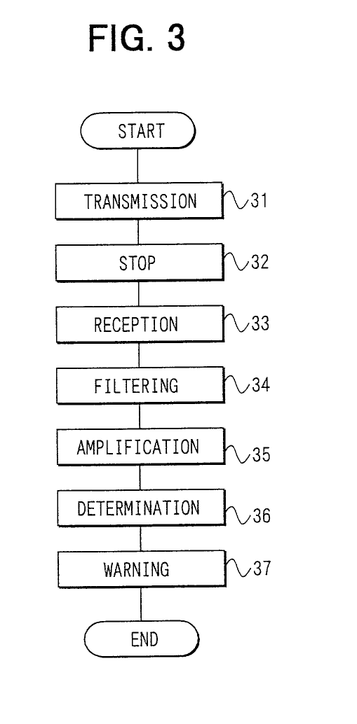

A sequence for detecting the obstruction in the ultrasonic sonar shown in FIG. 2 will be described with reference to FIG. 3.

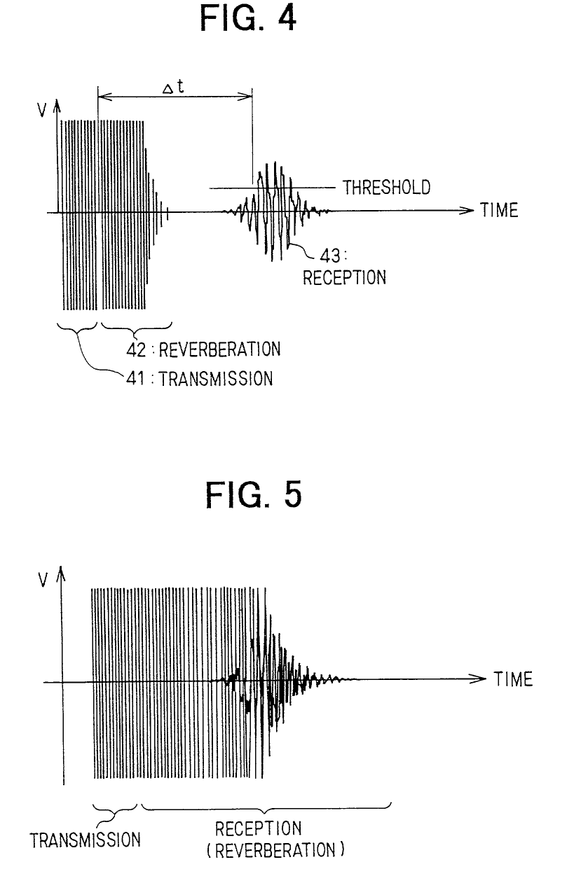

Ultrasonic is transmitted to an outside of the sonar from the ultrasonic transmitter and receiver 21 for a very short time (for example, ultrasonic at 40 KHz for 250 ps), while the transmission and reception switching means 22 is switched to a transmission mode at step 31. Transmission of the ultrasonic is stopped, and then, the transmission and reception switching means 22 is switched to a reception mode at step 32. The ultrasonic, which is reflected by an object (i.e., the obstruction) and returns, is received by the transmitter and receiver 21 at step 33. Electric noise included in a signal obtained by the received ultrasonic is filtered off by the LPF 25 at step 34. The filtered signal of the ultrasonic is amplified at a level where a microcomputer can recognize an amplified signal by the amplification circuit 26 at step 35. The detecting means 27 detects a distance between the ultrasonic sonar (i.e., the vehicle) and the obstruction based on an elapsed time (At in FIG. 4) from the stop of transmission of the ultrasonic to the reception of the received ultrasonic which is higher than a predetermined threshold value, by using a numerical expression 1 described below.

[EXP 1]

$$DISTANCE = \frac{sonic - speed}{time \times 2} \qquad [ EXP 1 ]$$

where, the DISTANCE designates the distance between the ultrasonic sonar and the obstruction, the sonic-speed designates sonic speed, and the time designates the elapsed time.

A warning according to the distance is announced to the user, which is changed in volume or tone based on the distance.

Next, an oscillation caused by reverberation will be described with reference to FIG. 4.

Even when the ultrasonic sensor 21 is stopped activating by the transmission and reception switching means 22, the oscillation 42 caused by the reverberation is subsequent to signal oscillation 41 since the ultrasonic sensor 21 has own natural vibration as shown in FIG. 4.

The ultrasonic sonar transmits the ultrasonic signal and receives reflected signal of the transmitted ultrasonic signal by using the one ultrasonic vibrator, and detects the obstruction by plus radar system, so that the ultrasonic vibrator mechanically continues inertial vibration (i.e., the reverberation) after being stopped transmitting the ultrasonic.

The reverberation is utilized to detect whether the ultrasonic vibrator works normally by detecting the length of the reverberation.

On the other hand, referring to FIG. 5, when the reverberation is too long, the reverberation overlaps the reception of the reflected signal, so that the reflected signal is hidden by the reverberation. Accordingly, the ultrasonic sonar cannot detect the obstruction.

The long reverberation is caused, for example, by adhesion of substance such as a water droplet to the diaphragm 11. By this adhesion, characteristic value and form of vibration of the diaphragm 11 are changed and cause the long reverberation.

The change of the reverberation will be described particularly.

When the substance such as the water droplet does not adhere to the diaphragm 11, even if the diaphragm 11 is varied in thickness, the reverberation is not so changed as to influence to detect the obstruction. On the other hand, when the substance adheres to the diaphragm 11, the reverberation is changed based on the thickness of the diaphragm 11. Particularly, the thinnest portion 15 of the diaphragm 15 may has a threshold value with respect to the change of the reverberation. Therefore, the thickness of the thinnest portion 15 of the diaphragm 11 should be designed in consideration of influence by the adhesion of the substance to the diaphragm 11, and the thickness should have a predetermined thickness or more.

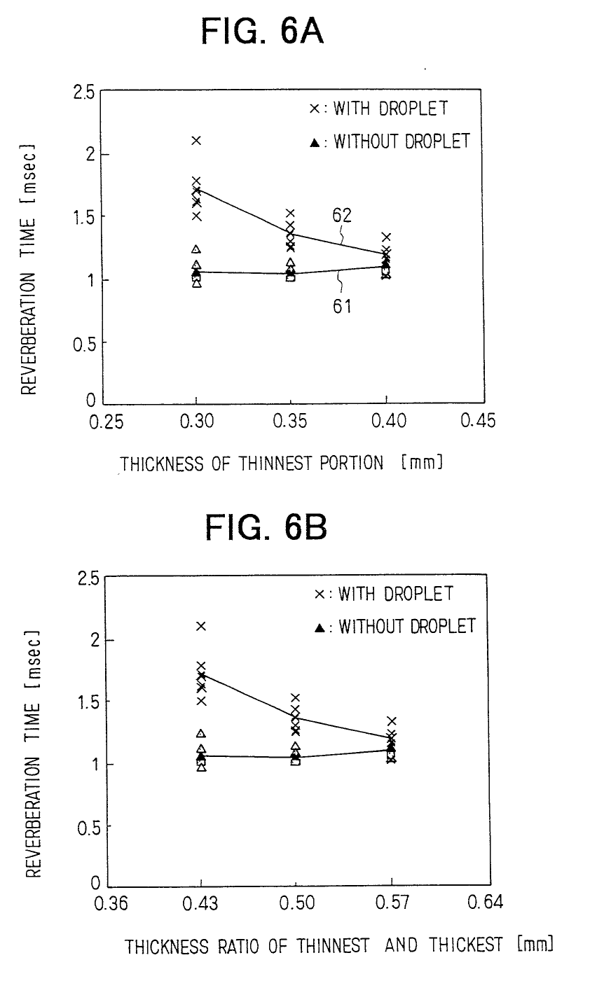

Referring to FIG. 6A, the reverberation time, which represents duration of the reverberation, does not change vary much when the water droplet does not adhere to the diaphragm 11 in a case that the thickness of the thinnest portion 15 is varied as shown on a line 61 in FIG. 6A. Consequently, the reverberation time is not affected by the thickness of the thinnest portion 15 when the substance (water droplet) does not adhere thereto. On the other hand, as shown on a line 62, the reverberation time is affected by the thickness of the thinnest portion 15 when the substance (water droplet) adheres thereto. In this case, the reverberation time decreases to such a degree that the water droplet does not adhere to the diaphragm 15 as the thickness of the thinnest portion 15 increases. Incidentally, the lines 61 and 62 show an average reverberation time of the respective samples, respectively. When the thickness of the thinnest portion 15 has a thickness of 0.30 mm, a difference in the average reverberation time between the case that the water droplet adheres to the diaphragm 11 and the case the water droplet does not adhere to the diaphragm 11 is 0.6 ms. This time corresponds to approximately 10 cm when the time is converted to distance by using expression 1 described above in a situation where the sonic speed is 340 m/s. Therefore, detection ability is lowered by 10 cm in comparison with normal condition of the diaphragm 11 (the water droplet does not adhere to the diaphragm 11). Besides, wrong warning may be announced by detecting the reverberation as the reflected signal.

When the thickness of the thinnest portion 15 has a thickness of 0.40 mm, a difference in the average reverberation time between the case that the water droplet adheres to the diaphragm 11 and the case the water droplet does not adhere to the diaphragm 11 is 0.09 ms. This time corresponds to approximately 3 cm when the time is converted to distance by using expression 1 described above in a situation where the sonic speed is 340 m/s. In this case, the difference of 0.09 ms (3 cm) is within tolerance, and does not affect to the detection.

Therefore, the thinnest portion 15 of the diaphragm 11 should be 0.4 mm or more as can be understood from FIG. 6A. When the thickness of the thinnest portion 15 is 0.4 mm or more (for example, 0.4 mm), the detection of the obstruction can be normally achieved in both cases that the substance such as the water droplet adheres to, and does not adhere to the diaphragm 11. Incidentally, in FIGS. 6A and 6B (described below), a condition of the experiment in the case that the water droplet adheres to the diaphragm 11 is that a water droplet having a diameter of 0.4 mm adheres to the thinnest portion 15, which is smaller than an area of the thinnest portion 15.

Moreover, in FIG. 6B, thickness ratio of the thinnest portion to a thickest portion of the diaphragm 11 on which the ultrasonic vibrator 14 is mounted (i.e., the center portion) replaces the thickness of the thinnest portion 15 as a horizontal axis shown in FIG. 6A. As can be understood from FIGS. 6A and 6B, the thickness ratio is preferably 0.57 or more, and less than 1.00 (0.57<=the thickness ratio<1.00) to restrain the reverberation efficiently, thereby being able to detect the reflected ultrasonic correctly. Therefore, thickness of the thickest portion and the thinnest portion are determined so as to satisfy the relationship described above.

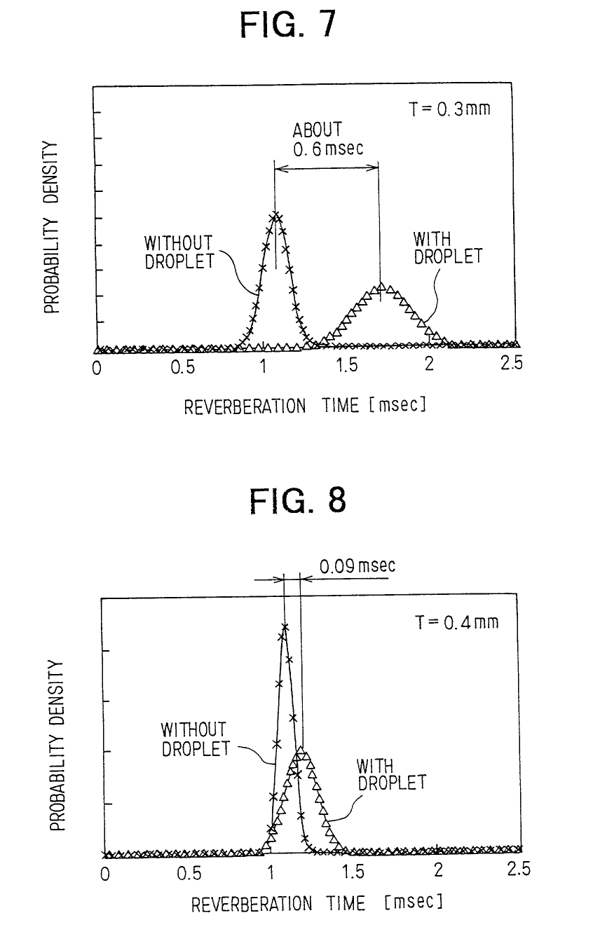

Referring to FIG. 7, when the thinnest portion 15 is 0.3 mm in thickness, the reverberation time in the case that the substance such as the water droplet adheres to the diaphragm 11 is different noticeably from that in the case that the substance does not adhere to the diaphragm 11 in the probability density.

As can be understood from FIG. 7, difference between the peaks is approximately 0.6 ms.

On the other hand, referring to FIG. 8, when the thinnest portion 15 is 0.4 mm in thickness, the reverberation time in the case that the substance such as the water droplet adheres to the diaphragm 11 is almost the same as that in the case that the substance does not adhere to the diaphragm 11 in the probability density. In this case, difference between the peaks is approximately 0.09 ms.

Thickness of the diaphragm 11 may be varied in accordance with each location in the diaphragm 11. When the thinnest portions 15 are located at end portions of the diaphragm 11, the diaphragm has good characteristics in power and directivity (that is, the directivity is narrowed), so that the end portions of the diaphragm 11 is preferably set to be a predetermined thickness by which the reverberation is not changed so much. Therefore, when a resonance value of the diaphragm 11 related to the reverberation is adjusted, it is preferable that the thickness of the end portions of the diaphragm 11 is remained in thickness of predetermined value or more.

While the present invention has been shown and described with reference to the foregoing preferred embodiment, it will be apparent to those skilled in the art that changes in form and detail may be therein without departing from the scope of the invention as defined in the appended claims.

What is claimed is:

1. An ultrasonic sensor comprising:
a vibrator causing ultrasonic in a sensor body; and
a diaphragm attached to the sensor body, transmitting the ultrasonic, and the vibrator being attached thereto,
wherein a thickness of the diaphragm is adjusted so that an elapsed time of a reverberation of the diaphragm is a predetermined value or less even when a substance adheres to the diaphragm.

2. An ultrasonic sensor according to claim 1, wherein the thickness of the diaphragm is adjusted so that the reverberation of the diaphragm disappears in a predetermined time after transmission of the ultrasonic is stopped and before reflected ultrasonic returns.

3. An ultrasonic sensor according to claim 2, wherein a thinnest portion of the diaphragm has a thickness of 0.4 mm or more.

4. An ultrasonic sensor according to claim 2, wherein the thinnest portion of the diaphragm is located at an end portion of the diaphragm.

5. An ultrasonic sensor according to claim 2, wherein the diaphragm serves as a receiver of the reflected ultrasonic.

6. An ultrasonic sensor according to claim 5, wherein the vibrator is attached to a thickest portion of the diaphragm.

7. An ultrasonic sensor according to claim 6, wherein the thickest potion of the diaphragm is located substantially center of the diaphragm, the thinnest portion of the diaphragm is arranged adjacent to the thickest portion of the diaphragm, and another thinnest portion of the diaphragm is arranged on an opposite side of the thinnest portion with respect to the center portion, wherein both the thinnest portion and another thinnest portion have a semicircle form, respectively.

8. An ultrasonic sensor according to claim 6, wherein a thickness ratio of the thinnest portion to the thickest portion is in a range between 0.57 and 1.00.
